(19) United States
(12) Patent Application Publication
(10) Pub. No.: US 2002/0045021 A1
(43) Pub. Date: Apr. 18, 2002

(54) Floor mat, system and method

(76) Inventors: V. Christopher Brown, LaGrange, GA (US); Amy B. Streeton, LaGrange, GA (US)

Correspondence Address: Milliken & Company, P.O. Box 1927, Spartanburg, SC, 29304, US

(21) Appl. No.: 09/927,016

(22) Filed: Aug. 9, 2001

Related U.S. Application Data
(60) Provisional application No. 60/224,310, filed on Aug. 10, 2000.

(51) Int. Cl. B32B 3/14

(52) U.S. Cl. 428/47; 428/95; 428/192; 156/250

(57) ABSTRACT

A floor mat, system and method, wherein one embodiment of the mat comprises a nonwoven substrate through which carpet pile fibers are tufted and which also comprises either a foam rubber backing sheet which exhibits the same degree of shrinkage as the carpet pile component or a rubber backing sheet which possesses a strength modulus above about 1,000 pounds per square inch. With such backing sheet requirements either the overall shrinkage of the mat will be even or the backing sheet will be strong enough to compensate for varying degrees of shrinkage between the pile substrate and the backing sheet. The resultant floor mat meets industrial laundry standards of rippling (i.e., curling up) and delaminating (i.e., loosening and ultimate falling out of tufted pile fibers), preferably utilizes a nonwoven carpet pile substrate, and is able to withstand vigorous laundry processes without either damaging the subject rotary washer or centrifugal dryer or becoming damaged itself upon exposure to such harsh conditions.

### CROSS-REFERENCE TO RELATED APPLICATIONS

This application claims priority to and benefit of U.S. Provisional Patent Application Serial No. 60/224,310, filed on Aug. 10, 2000, and hereby incorporated by reference herein.

### FIELD OF THE INVENTION

This invention relates to floor mats typically having a carpet pile substrate and a rubber backing, a system of such mats, distinctive designs, and methods of producing and using such mats.

### BACKGROUND

Floor mats have long been utilized to facilitate the cleaning of the bottoms of people's shoes, particularly in areas of high pedestrian traffic such as doorways. Moisture, dirt, and debris from out of doors easily adhere to such footwear, particularly in inclement weather and particularly in areas of grass, mud or the like. Such unwanted and potentially floor staining or dirtying articles need to be removed from a person's footwear either prior to entry indoors or someplace within an edifice in order to prohibit, or at least diminish, the transfer or “re-tracking” of dirt and debris from persons' shoes to floor coverings. As will be appreciated, such floor (and/or dust control) mats by their nature must undergo frequent repeated washings and dryings so as to remove the dirt and debris deposited thereon during use. These mats are generally rented from service entities, such as laundry services, which retrieve the soiled mats from the user and provide clean replacement mats on a frequent basis. The soiled mats are thereafter cleaned and dried in an industrial laundering process, such as in rotary washing machines and centrifugal dryers, and then sent to another user in replacement of newly soiled mats.

Such floor mats have had at least three significant problems arising from frequent washings and harsh environments of use. First, the energy required to wash and dry a typical floor mat is significant due to the overall mass of the mats. This overall mass is made up of the mass of the mat pile, the mass of the carrier fabric into which the mat pile is tufted, and most significantly, the mass of the rubber backing sheet which is integrated to the carrier fabric under heat and pressure.

A second problem which is frequently encountered, particularly with laundered floor mats, is the susceptibility of such mats to rippling, or rolling up, of the rubber backing, rubber borders, and carpet pile substrate due to uneven shrinking of those components upon exposure to heat in the centrifugal dryers. This problem may result in a mat which will not lie flat on a desired surface without the need for added weight, and thus undesired and aesthetically displeasing obstacles, placed in the areas of curling on the subject mat.

A third major problem has been the delamination of carpet pile fibers from woven or knit pile substrates within standard floor mats. By delamination, it is meant the carpet fibers will become disassociated from the substrate due to the weakening of the pile substrate over time, particularly upon exposure to the rigors of periodic industrial laundering. Frequently this weakening of the pile substrate occurs unevenly thus resulting in a carpet pile which loses its tufted fibers in discrete areas of the mat. Such delamination, particularly in a haphazard fashion, results in, again, a mat which is aesthetically displeasing.

Floor and/or dust control mats have been developed in the past which provide an easy manner of cleaning the soles of a person's shoes simply by scraping the footwear against such a stiff article. Examples of such floor mats or carpet piles are exemplified in U.S. Pat. No. 1,008,618, to Skowronski et al.; U.S. Pat. No. 4,045,605, to Breens et al.; U.S. Pat. No. 3,306,808, to Thompson, et al.; U.S. Pat. No. 4,353,944, to Tarui; U.S. Pat. No. 4,741,065, to Parkins; U.S. Pat. No. 4,886,692, to Kerr et al.; U.S. Pat. No. 5,227,214, to Kerr et al.; U.S. Pat. No. 5,305,565, to Nagahama et al.; U.S. Pat. No. 5,350,478, to Bojstrup et al.; and U.S. Pat. No. 5,680,826, to Nagahama et al.; as well as French Patent No. 1,211,755, assigned to Cosyntex (S.A.) and PCT Application 95/30040, assigned to Kleen-Tex Industries, Inc., all of which are incorporated herein by reference.

Copending U.S. patent application Ser. No. 09/128,289, filed on Aug. 3, 1998, hereby incorporated by reference herein, and corresponding Japan Patent No. 3009880, granted Dec. 3, 1999, describe a floor (and/or dust) mat which will withstand the rigors associated with rotary washing and centrifugal drying on an industrial scale and is not susceptible to an appreciable amount of rippling upon periodic cleaning, a floor (and/or dust) mat which is comprised of a nonwoven carpet pile substrate which is not susceptible to weakening of carpet pile tufts and thus will not easily experience delamination of the carpet fibers from the pile substrate, a floor (and/or dust) mat which comprises a nonwoven carpet pile substrate which possesses the same degree of shrinkage as the foam rubber backing sheet of the same mat, a floor (and/or dust) mat which comprises solid rubber reinforcement borders which possess the same degree of shrinkage as both the nonwoven carpet pile substrate and the foam rubber backing sheet, a floor mat which comprises a nonwoven carpet pile substrate having a low shrinkage rate with a solid rubber backing sheet having a strength modulus high enough to compensate for rubber sheet shrinkage (due to exposure to conditions such as high washing or drying temperatures) which is greater than the shrinkage rate of the carpet pile substrate in order to provide a floor mat which retains its flat position as vulcanized rather than rolling up, and a floor mat which may be printed with any design, logo, and the like, which will remain aesthetically pleasing over a duration of usual use and industrial laundering.

A need still exists for an improved, industrially launderable or cleaned, floor mat, system, and method of producing and using such mats.

### SUMMARY OF THE INVENTION

As will be appreciated, a reduction in the overall mass of the floor mat will result in a reduced energy requirement in washing and drying the mat. Moreover, a relative reduction in the mass of both the carpet pile substrate (carrier fabric for the carpet pile) and the rubber backing sheet (the heaviest component) will provide substantial benefits in this area. The floor mat of the present invention includes a lighter weight carpet pile substrate and a lighter weight rubber backing. The rubber backing sheet of the inventive mat may also possess a specific gravity which is approximately 25 percent less then the rubber sheets of typical prior floor mats (less than about 0.98) upon addition of a blowing agent during vulcanization in order ultimately to form a foam rubber sheet. Accordingly, with such a decrease in the overall weight of the mat, the overall energy requirements associated with the cleaning and handling of these mats is substantially reduced over that of prior mats. All of these improvements provide a decrease in energy costs which translates into reduced costs for the consumer.

The mat of the present invention may incorporate a specific rubber composition for the backing sheet and reinforcement borders which either possesses the same degree of shrinkage as the carpet pile substrate or possesses a sufficiently high modulus strength to compensate for any shrinkage variations.

The inventive mat may utilize a specific nonwoven pile substrate through which the carpet pile fibers are tufted. Such a nonwoven construction provides the desired benefit of reduced capability of delamination by more effectively, more uniformly, and more strongly holding the tufted carpet pile fibers in place throughout the life of the mat, even upon exposure to vigorous laundry processes. The particularly useful nonwoven substrate also exhibits a shrinkage rate on a dye range of from about 2.0 to about 2.5% which is well below the standard rate for nonwoven substrates of from about 3.5 to about 7.5%. The shrinkage rate of the specific nonwoven substrate also matches that of the rubber backing sheet and solid reinforcement borders which, again, provides the beneficial non-rippling effects discussed above. Such a specific nonwoven floor mat carpet pile substrate is preferably used in combination with the specific low shrinkage or high modulus strength rubber backing and solid rubber border reinforcement strip compositions.

In accordance with one aspect of the invention, an industrially launderable floor mat may be comprised of a carpet pile, including a nonwoven substrate having a shrinkage rate of about 2.0 to about 2.5%, and a rubber or foam rubber backing sheet possessing the same degree of shrinkage as the nonwoven carpet pile substrate, or a nonwoven carpet pile substrate possessing a shrinkage rate of from about 2.0 to about 2.5% and a solid rubber backing sheet having a strength modulus of greater than about 1,000 pounds per square inch. Nonwoven carpet pile substrates for use with floor mats have been discussed within the prior art, such as within the Parkins patent, above. However, such disclosures were limited to the possibility of utilizing nonwoven substrates as acceptable alternatives to woven, knit, and the like, substrates. There is no teaching which requires or even makes specific mention as to the importance of a specific nonwoven carpet pile substrate construction.

It is an object of this invention to provide a floor (and/or dust) mat which will withstand the rigors associated with rotary washing and centrifugal drying on an industrial scale and is not susceptible to an appreciable amount of rippling upon periodic cleaning. Furthermore, it is an object of the invention to provide a floor (and/or dust) mat which is comprised of a nonwoven carpet pile substrate which is not susceptible to weakening of carpet pile tufts and thus will not easily experience delamination of the carpet fibers from the pile substrate. Still a further object of this invention is to provide a floor (and/or dust) mat which comprises a nonwoven carpet pile substrate which possesses the same degree of shrinkage as the foam rubber backing sheet of the same mat. Yet another object of the invention is to provide a floor (and/or dust) mat which comprises solid rubber reinforcement borders which possess the same degree of shrinkage as both the nonwoven carpet pile substrate and the foam rubber backing sheet. One additional object of the invention is to provide a floor mat which comprises a nonwoven carpet pile substrate having a low shrinkage rate with a solid rubber backing sheet having a strength modulus high enough to compensate for rubber sheet shrinkage (due to exposure to conditions such as high washing or drying temperatures) which is greater than the shrinkage rate of the carpet pile substrate in order to provide a floor mat which retains its flat position as vulcanized rather than rolling up. Yet another object of the invention is to provide a floor mat which may be printed with any design, logo, and the like, which will remain aesthetically pleasing over a duration of usual use and industrial laundering.

Accordingly, this invention encompasses a floor mat including

a carpet substrate;

a vulcanized rubber backing;

and

optionally, rubber reinforcement strips present along at least a plurality of borders of the floor mat;

wherein the floor mat possesses suitable flexibility to be laundered on a regular basis in a standard industrial washing machine without appreciably damaging the mat or the machine.

Also encompassed within this invention is a floor mat including

a nonwoven carpet pile backing;

a pile material tufted into the nonwoven carpet pile backing which forms a pile surface on one side of the backing;

a vulcanized expanded rubber backing sheet of rubber integrated to the other side of the backing; and

optionally, solid vulcanized rubber reinforcement strips present along at least a portion of the borders of the mat;

wherein the floor mat possesses suitable flexibility to be laundered on a regular basis in a standard industrial washing machine without appreciably damaging the mat or the machine; and

wherein the nonwoven carpet pile backing possesses a shrinkage factor of from about 2.0 to about 2.5% and the rubber backing sheet possesses a modulus strength of greater than about 1,000 pounds per square inch.

The inventive floor mat generally comprises any type of standard carpet pile fibers tufted through a woven or nonwoven carpet pile backing to form a carpet substrate. The carpet fibers become attached to the rubber backing sheet upon vulcanization. Such fibers may be natural or synthetic, including, without limitation, cotton, ramie, polyester, nylon, polypropylene, and the like, as well as blends of such fibers. The fibers may be coarse or fine in structure as well. The fibers may also be white or solution dyed nylon fibers. Such pile fibers may provide a white or colored pile surface for jet dyeing or overprinting with different dyes in order to provide aesthetically pleasing designs, patterns, colorations and shades on the floor mat pile surface.

In accordance with a preferred embodiment of the present invention, the carpet substrate is a loop or cut pile of white nylon fibers which have been injection dyed, jet dyed, or printed with a coloration, pattern, design or the like of a plurality of colors and done so in a manner mimicking a carpet substrate produced with solution dyed yarn on a graphics tufting machine.

The floor mats may be perforated, may include anti-creep cleats, protrusions or nubs, may be cushioned, may be reinforced, may contain anti-microbial agents, may be static dissipative, or the like.

U.S. Pat. No. 5,305,565, to Nagahama et al., previously entirely incorporated by reference, shows the usual manner of producing floor mats comprising a base cloth, a mat pile tufted in the base cloth, and a rubber backing sheet. This reference, however, makes no mention as to the importance of a nonwoven carpet pile backing having a particularly low shrinkage rate nor any discussion of the importance of either a similar shrinkage rate for its foam rubber backing sheet or a necessarily high strength modulus for a solid rubber backing sheet. For the inventive floor mat, the attachment of the rubber sheet component to the carpet pile fibers may be accomplished either during the actual vulcanization step, as taught in Nagahama et al., for example, above, or through the use of an adhesive layer, preferably a polyolefin adhesive, between the carpet pile and the rubber sheet, as disclosed in copending U.S. patent application Ser. No. 08/732,866, to Kerr, or U.S. Pat. No. 5,968,631, both hereby entirely incorporated by reference, or any other like procedure.

If the backing sheet is a solid rubber, as noted above, it should possess a modulus strength of greater than about 1,000 pounds per square inch. Modulus strength for rubber is generally defined as the force required to physically stretch cured rubber specimens typically at 300% elongation and is determined by utilization of a tensile tester. The high modulus strength is important for a couple of reasons. Primarily, the nonwoven substrate will shrink upon use and periodic industrial laundering while the solid rubber will not shrink at the same rate, if at all. Thus, the high modulus strength solid rubber will not exhibit any rippling effects of the nonwoven substrate even with a high variation in shrinkage rates. Furthermore, rippling should not occur with such a high modulus strength solid rubber because the force needed to distort or disfigure the backing sheet will not be met through standard use and industrial laundering.

Solid rubber reinforcement strips may also be added around the borders of the mat, either by hand or in an in-line process, such as in U.S. Pat. No. 5,834,086, hereby incorporated by reference herein, or in Patent Cooperation Treaty Publication 96/38298, to Milliken Research Corporation. Such strips must either possess roughly the same shrinkage rate factor as the carpet pile substrate and the foam rubber backing sheet or they must possess roughly the same modulus strength of the solid rubber backing sheet, all in order to ensure the probability of rippling (or curling) of the mat will be minimal. Such strips may be comprised of any type of butadiene rubber, such as acrylonitrile-butadiene (NBR) or styrene-butadiene (SBR), or carboxylated derivatives of such butadienes, merely as examples. Preferably, the strips are comprised of NBR as carboxylated NBR is cost prohibitive.

The carpet fibers may be colored or dyed through any acceptable method so as to produce aesthetically pleasing designs within the carpet pile portion of the inventive mat.

For example, white yarn may be colored or patterned using a dye injection machine such as a Millitron® dye machine of Milliken & Company. It is preferred that the carpet pile be dyed or printed in broadloom form (6′ or 12′ wide), cut into mat sized blanks, placed on the rubber backing, and then vulcanized. Alternatively, one may use an overprinting procedure on 100% solution dyed nylon fibers. Such nylon is acid-dyeable and available from Cookson Fibers. As noted above, such pile fibers allow for pleasing and long-lasting colorations and shades of color to be applied and retained on the pile surface through the utilization of acid dyes. With such fibers, any design or configuration may be produced (as well as logos, pictures, and the like) on the pile surface, again in order to provide a long-lasting aesthetically pleasing floor mat for the consumer. Furthermore, the mat itself can be made in any shape, with rectangular or square configurations being preferred.

As noted above, the inventive floor mat can easily be removed from the floor or ground and can be easily laundered through, preferably, industrial washing processes utilizing standard heavy duty washing machines. For this reason, the inventive floor mat should have a backing sheet which possesses suitable flexibility so as not to damage such machinery (not to mention itself) when subjected to such rigorous cleaning procedures. Although the inventive floor mat can withstand the rigors of industrial machine washing, hand washing or any other manner of cleaning may also be utilized. Since the inventive mat is able to withstand such industrial cleaning procedures, the inventive mat provides a long-lasting article which is easily cleaned, and thus remains aesthetically pleasing to users (i.e., pedestrians) over the life of the mat. All of this translates into reduced cost for the consumer as fewer mats need to be purchased in order to provide a suitable barrier to outdoor dirt and moisture. Furthermore, because of the utilization of a nonwoven carpet pile substrate, the carpet pile fibers of the inventive floor mat will, as noted above, remain tufted over a sustained period of time and upon periodic exposure to harsh industrial laundry procedures. Additionally, the inventive floor mat will not be susceptible to curling or rolling up (rippling) and thus will pose a decreased risk of harm to pedestrians when compared to the mats of the prior art. Overall, the inventive floor mat provides an article which will retain its aesthetically pleasing characteristics over a long period of time and which thereby translates into reduced costs for the consumer.

Also, in accordance with one aspect of the present invention, there is provided a system of floor mats wherein each of the floor mats is provided in a limited selection of sizes to accommodate mass production of a plurality of floor mats during one press or vulcanization cycle. For example, there is provided four sizes, 28″×42″, 28″×59″, 49″×57″, and 28″×100″, which replace conventional mat sizes 3′×4′, 3′×5′, 4′×6′, and 3′×10′, respectively.

This new selection of sizes reduces manufacturing costs, reduces waste, and standardizes mat racks, slots, holders, bins, etc. Plus, the 28″ width allows the mats to fit within a 3′ wide door opening.

Still further, the selection of sizes of the present mat system is preferably dovetailed with a selection of colors or designs to further enhance the system, reduce costs, and standardize inventory. For example, the carpet or pile can be offered in 6 colors or colorations and 3 different border colors.

Also, in accordance with one aspect of the present invention, the borders of the mat are colored, for example, blue, gray, or taupe, by adding a frame or layer of colored rubber or other polymer over the rubber backing prior to placing the carpet substrate thereon upstream of the vulcanization of the layered structure.

In accordance with another embodiment of the present invention, a plurality of floor mat precursors can be formed on a single, large sheet of rubber backing material by placing a plurality of spaced carpet substrate pieces on the single large sheet and then vulcanizing. Individual floor mats are produced by cutting between the carpet substrates. If placement of the carpet substrates on the large sheet and cutting between the carpet substrates following vulcanization are done accurately, then there is substantially no rubber backing trim waste. If the corners of the mats are rounded, there may be a small amount of trim waste at the corners.

### BRIEF DESCRIPTION OF THE DRAWINGS

FIG. 1 is a schematic side view representation of a floor mat manufacturing machine.

FIG. 2 is a perspective view which illustrates a molded floor mat as it exists within the mat manufacturing machine of FIG. 1.

FIG. 3 is a partial cross-sectional view of a completed vulcanized floor mat of the instant invention.

FIG. 4 is a top view with a portion of the carpet substrate removed and illustrating the rubber backed mat produced in accordance with one embodiment of the present invention.

FIG. 5 is a cross section view along line 5-5 of FIG. 4 prior to vulcanization.

FIG. 6 is a cross section view similar to FIG. 5 following vulcanization.

FIG. 7 is a cross section view similar to FIG. 5 except that the added elements are on a border outside of the carpet substrate.

FIGS. 8-11 are respective top view illustrations of a large multi-mat precursor (plurality of mats) in accordance with selected embodiments of the present invention.

FIGS. 12 and 13 are selected layout options in accordance with particular examples of the present invention.

FIGS. 14 through 19 are partial top views of particular colorations, patterns, or designs in accordance with particular examples of the present invention. More particularly these colorations or designs are Stellar Indigo, Stellar Jade, Stellar Ash, Stellar Onyx, Stellar Suede, and Stellar Rose.

FIGS. 20 through 22 are exemplary top view illustrations of particular colorations, patterns, or designs with different colored borders or top layers. More particularly, they illustrate Stellar Indigo with a gray border, Stellar Indigo with a navy border, a Stellar Indigo with a taupe border.

### DETAILED DESCRIPTION OF THE INVENTION

While the invention will be described in connection with certain preferred embodiments and practices, it is to be understood that it is not intended to in any way limit the invention to such embodiments and practices. On the contrary, it is intended to cover all alternatives, modifications and equivalents as may be included within the spirit and scope of the invention as defined by the appended claims.

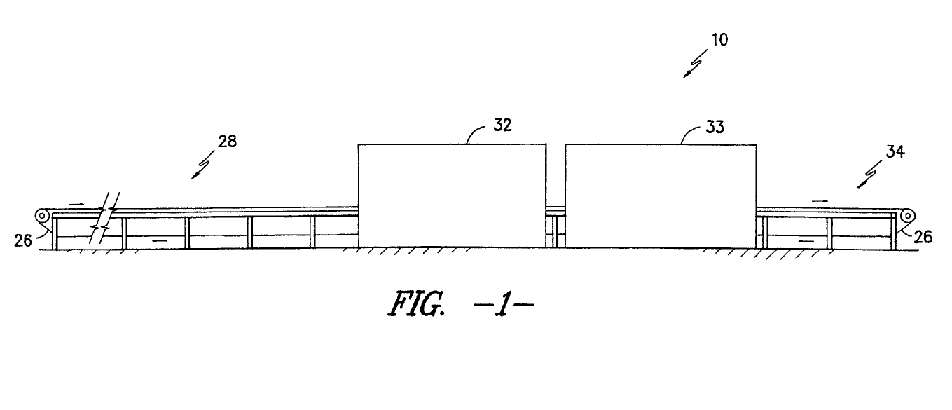

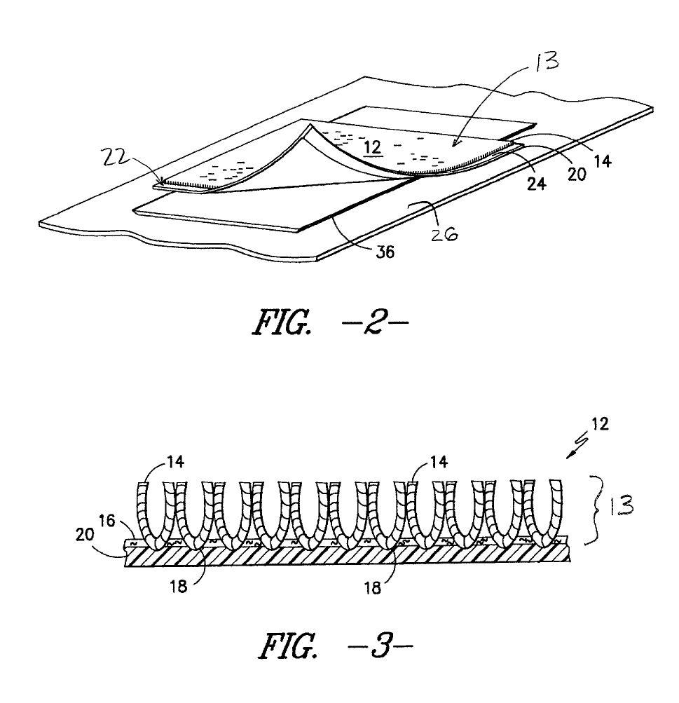

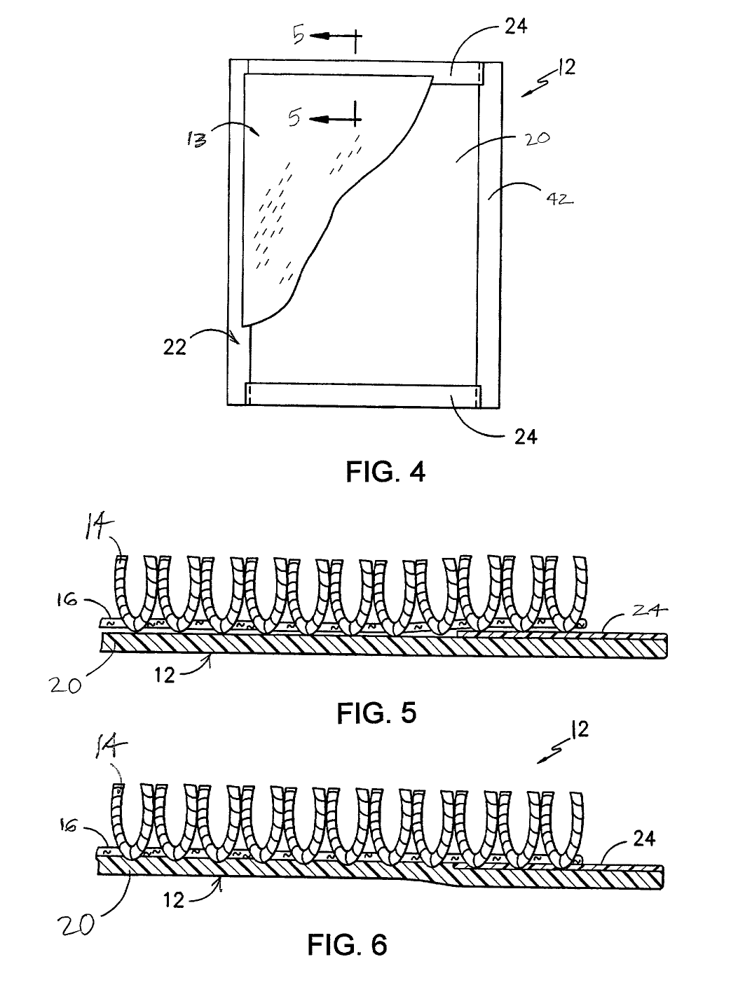

Turning now to the drawings wherein like elements are designated by like reference numerals in the various views, in FIG. 1 there is shown a schematic of a floor mat manufacturing machine 10 for producing the exemplary floor mat 12 (FIGS. 2 and 3) of the present invention. In the illustrated and preferred form of the invention, the floor mat 12 comprises a carpet substrate 13 including pile yarns 14 of natural or synthetic fibers (such as cotton, ramie, polyester, nylon, polypropylene, and the like) or blends thereof, solution dyed nylon pile fibers, or white nylon pile fibers tufted through a woven or nonwoven pile backing (carrier layer) 16 comprised preferably of polyester or nylon coated polyester (although nylon, polypropylene, cotton, and the like may also be utilized) with the bottom 18 of the tufts adhered to a rubber backing sheet 20. This adherence of the rubber backing sheet 20 to the nonwoven pile substrate 16 and bottom 18 of the tufts is effected during vulcanization (i.e. cross-linking) of the rubber backing sheet under heat and pressure as is well known to those of skill in the art. It is thus of utmost importance for the pile backing 16 to bond well to the rubber backing sheet 20 comprised of one or more layers of foam and/or solid rubber in order to produce a long-lasting floor mat. If desired, the bottom of the rubber backing sheet may also include a plurality of anti-creep cleats (not shown) as are well known in the art. For example, as described in U.S. Pat. Nos. 4,761,065; 5,170,526; and 5,227,214 hereby incorporated by reference. As shown in FIG. 2, the floor mat 12 of the present invention also preferably includes a pile-free or pileless border portion 22 around the perimeter, for example, comprised of solid rubber reinforcement strips 24 which become vulcanized simultaneously with the mat. For example, as described in FIGS. 4-6 and U.S. Pat. No. 5,928,446 hereby incorporated by reference. Such border portion strips 24 may be added by hand prior to vulcanization or they may be adhered to the rubber backing sheet 20 through an in-line procedure as taught within U.S. Pat. No. 5,928,446.

The floor mat 12 of the present invention is assembled molded and vulcanized on the manufacturing machine 10 of FIG. 1. The manufacturing machine 10 which is well known to those of skill in the art includes an endless, teflon coated conveyor belt 26 to carry the floor mats 12 from an assembly station 28, into a press molding apparatus 32, to a post cure oven 33, and out to a separating station 34. The press molding apparatus 32 can be of any type which is suitable such as that shown in U.S. Pat. 4,447,201 to Knudsen (incorporated by reference).

In production of the floor (and/or dust control) mat or mats 12 of the present invention, the mat components are preassembled at station 28 by laying down a metal plate or silicone or butyl pad 36 on the conveyor belt 26. The rubber backing sheet 20 as described more fully below is placed over the silicone pad and the tufted fabric 13 comprising the pile yarns 14 tufted through the nonwoven pile backing 16 and the rubber reinforcement strips are placed on top of the rubber backing sheet 20. In the preferred practice, the rubber backing sheet laid down at the assembly station 28 is a solid calendered sheet of green (i.e. unvulcanized) acrylonitrile-butadiene rubber (NBR).

The conveyor belt 26 is then indexed to place the preassembled mat components into the press mold 32 while an additional mat or mats are preassembled at station 28. While the first mat or mats are in the press mold 32, they are exposed to a temperature between about 250° F. and about 320° F. While in the press mold 32, the mats are exposed to pressures in the range of between about 20 psi and 40 psi. At the temperature and pressure occurring in the press mold 32, the rubber backing sheet 20 undergoes vulcanization and is integrated to the carrier layer 16 (and back of the pile yarns) of the mat to form a substantially unitary structure. After about 3 to 6 minutes, the conveyor belt 26 is again indexed to move the first vulcanized mat or mats into the post cure oven 33 to complete the vulcanization but without the application of pressure. During this time yet an additional mat or mats are preassembled at station 28 while the second mat or mats are indexed to the press mold.

As will be described in more detail later, in accordance with one embodiment of the present invention, a mat precursor having a plurality of carpet substrates (and reinforcement strips if desired) placed on a single large sheet of rubber backing is fed to the press mold and later cut between the carpet pieces to form individual mats.

In the preferred practice, the post cure oven is operated at a temperature between about 280° F. and 300° F. but no pressure is applied to the mat. After another 3 to 6 minutes, the conveyor belt is again indexed to move the first mat or mats into the stripping (separating or cutting) station 34 wherein they are removed from the silicone pad 36 and the conveyor belt 26 (FIG. 2) while the second, and third sets of mats are indexed into the post cure oven 33, and the press mold 32 respectively, and a fourth sets of mats is preassembled at station 28. As will be appreciated, the mat or mats may also undergo a preheating operation prior to entering the press mold if desired as described in U.S. Pat. No. 4,886,692, to Kerr (incorporated by reference).

With reference to FIGS. 4-6 of the drawings, reinforcing and/or coloring strips 24 are added over rubber backing sheet 20 prior to placement of carpet substrate 13 thereon.

As shown in FIGS. 4-6 of the drawings, the side or border strips 24 extend inwardly of the edge of the carpet substrate.

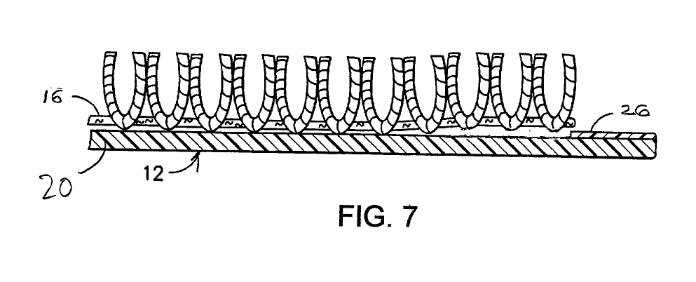

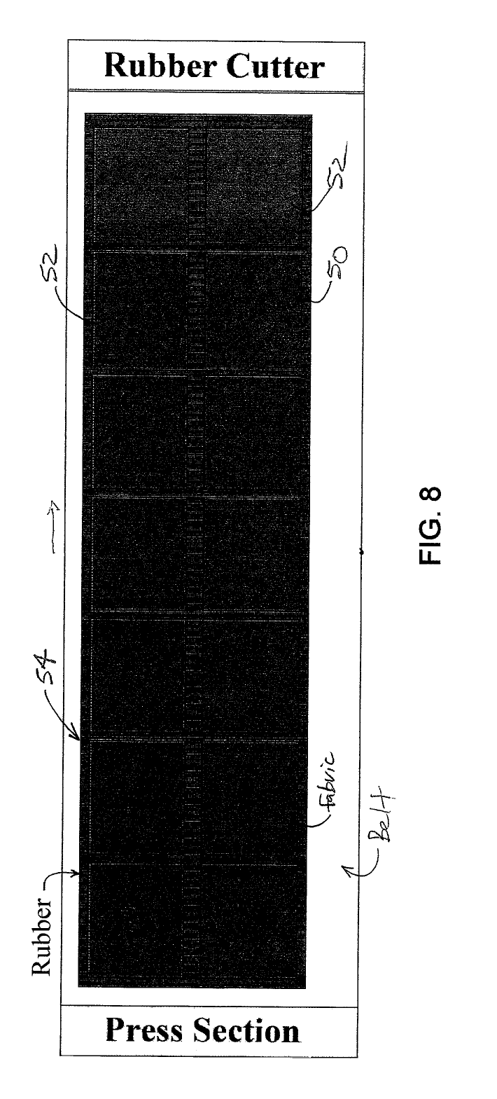

With reference to FIG. 7 of the drawings, a narrower edge or border strip 26 may be used so that the reinforcing and/or coloration is merely on the portion of the border which extends beyond the edge of the carpet substrate 13 or tufting 14.

Also, it is to be understood that the edge or border strips may be instead a frame-like item which is placed over the rubber backing sheet or which actually forms part of the rubber backing sheet or a top layer thereof.

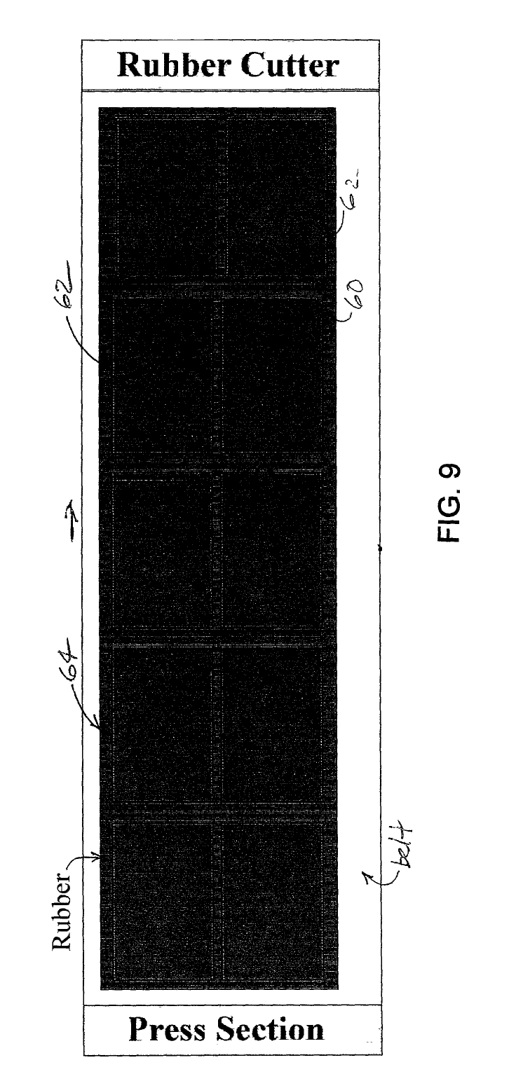

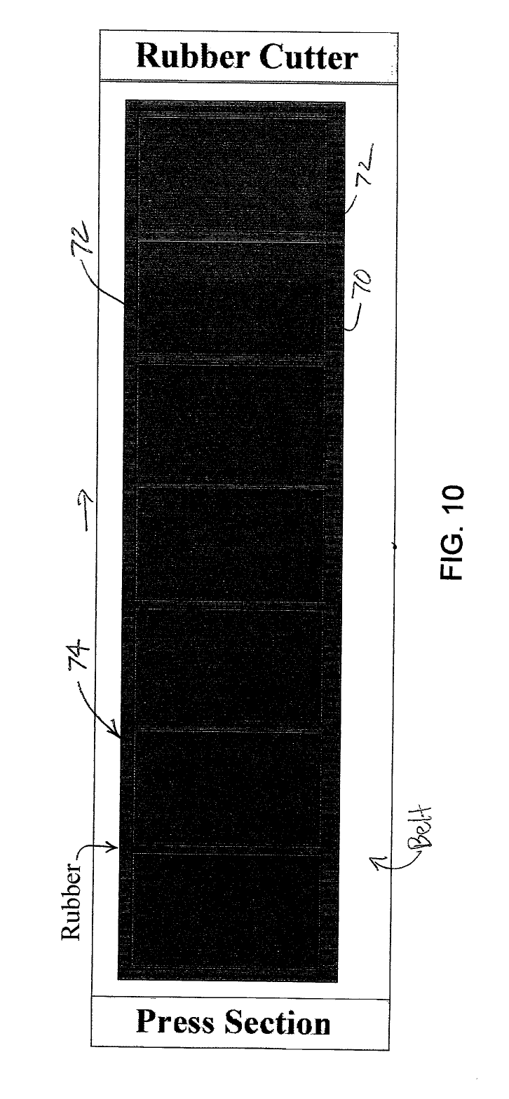

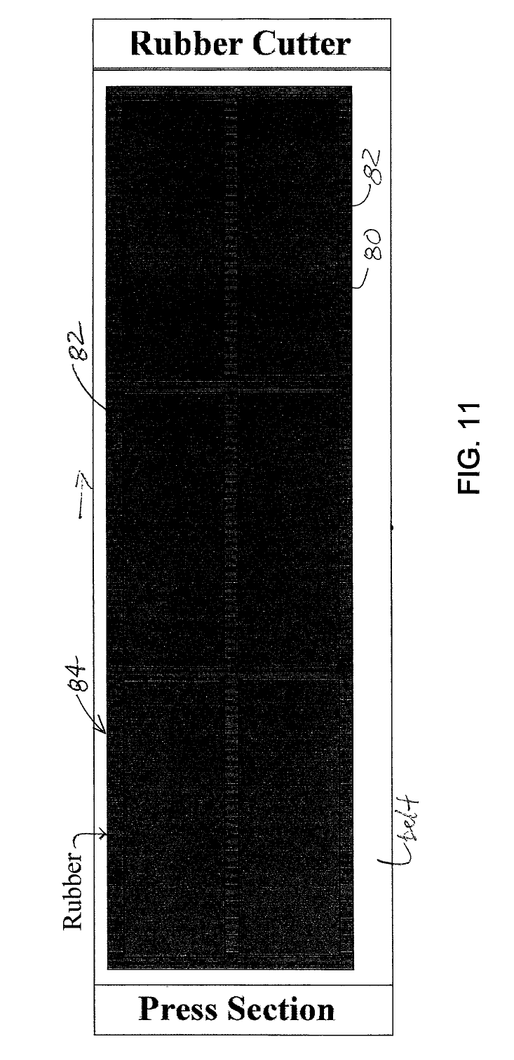

With reference to FIGS. 8-11 of the drawings, and in accordance with one aspect of the present invention, a plurality of floor mats or floor mat layered assemblies may be formed at one time in the press and thereafter cut apart to form a plurality of individual floor mats, by placing a plurality of carpet pieces or fabric substrate pieces 52 atop a single large rectangular piece of rubber backing sheet 50 atop a belt 26. The plurality of carpet pieces (14 pieces shown in FIG.8) in combination with the large rubber backing sheet 50 together form a multiple floor mat or multi-floor mat precursor 54 which is cut apart between the carpet pieces 52 to form individual floor mats 12. Likewise, multiple floor mat precursors 64, 74, and 84 of FIGS. 9-11 are made up of rubber sheets 60, 70, 80, and carpet pieces or fabric substrate pieces 62, 72, and 82, respectively. With respect to FIGS. 8-11, respectively, 14, 10, 7, and 6 floor mats are formed or vulcanized simultaneously.

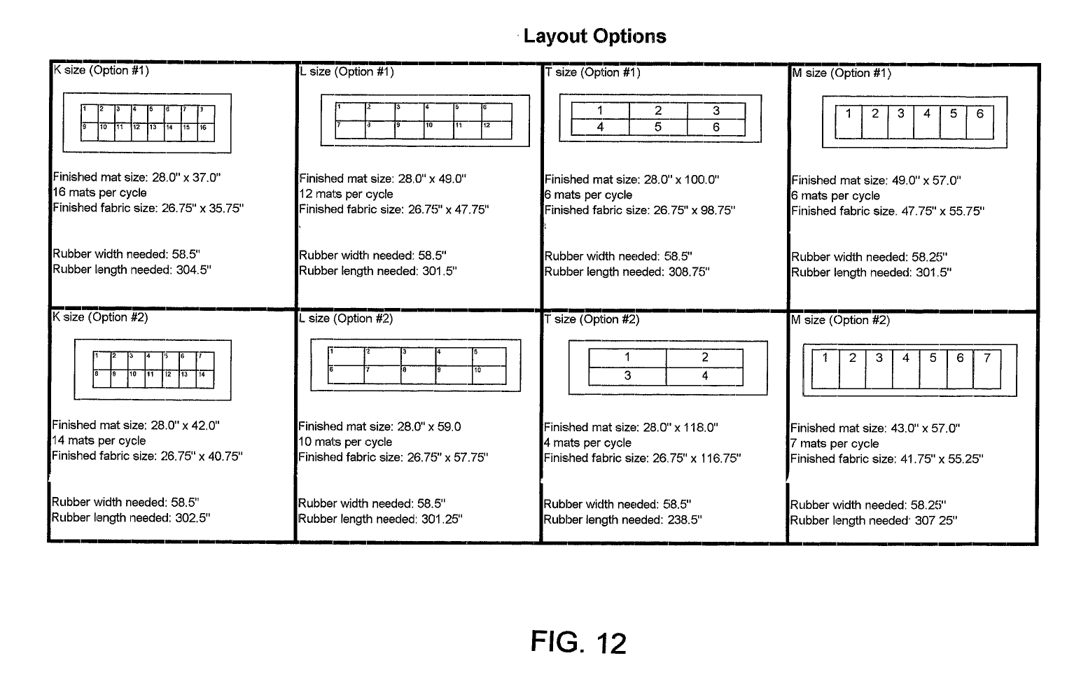

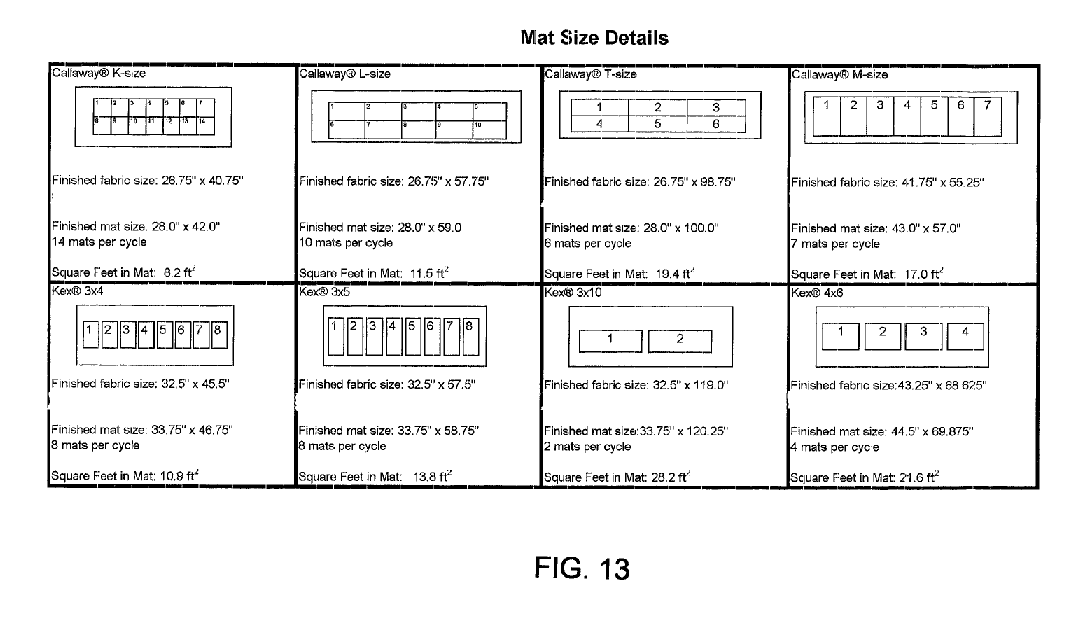

FIGS. 12 and 13 illustrate respective examples of particular floor mat layout options for forming a plurality of floor mats at the same time as previously described with respect to the examples shown in FIGS. 8-11.

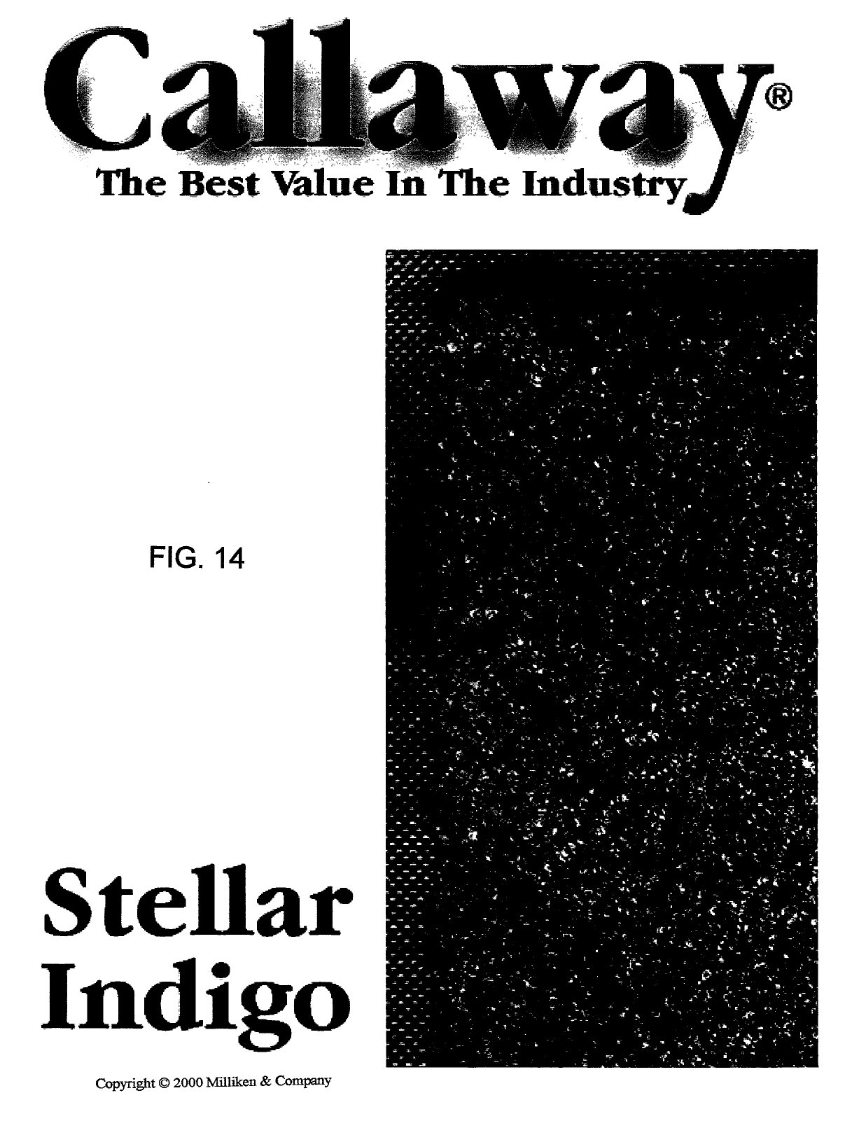

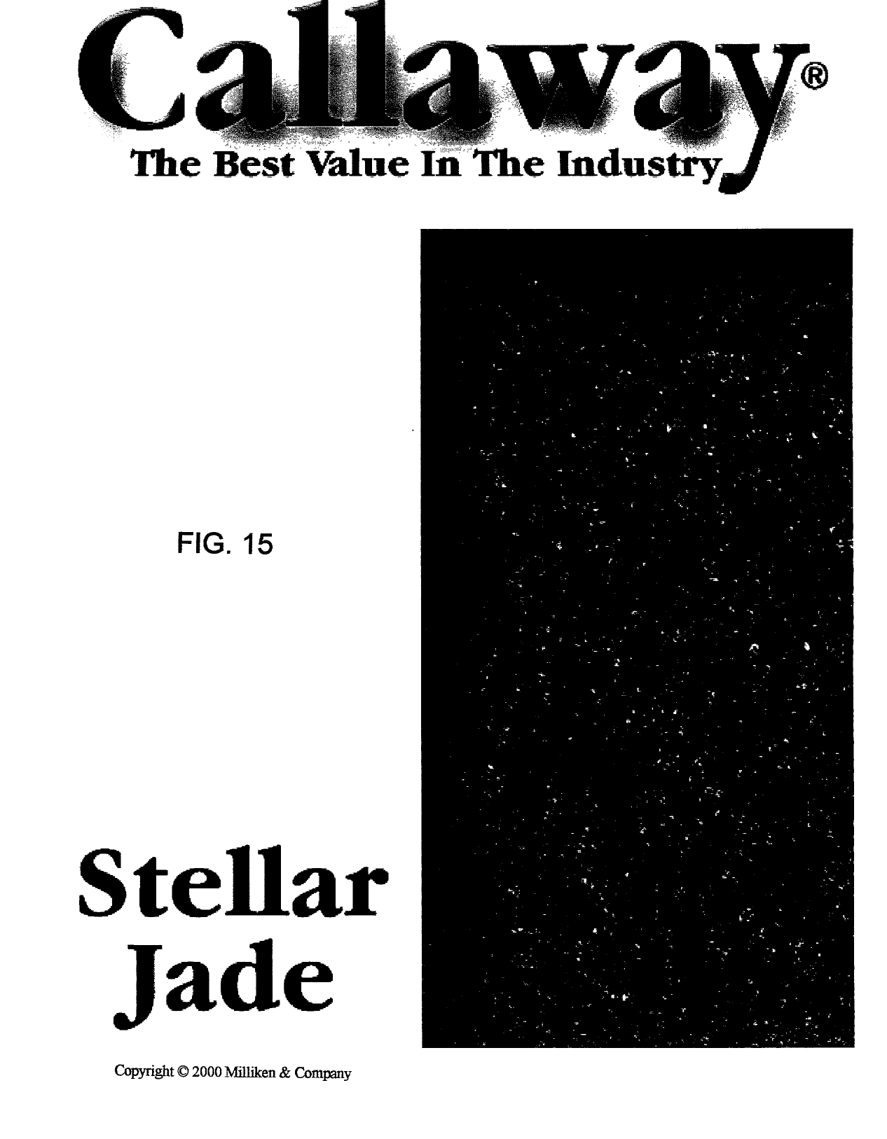

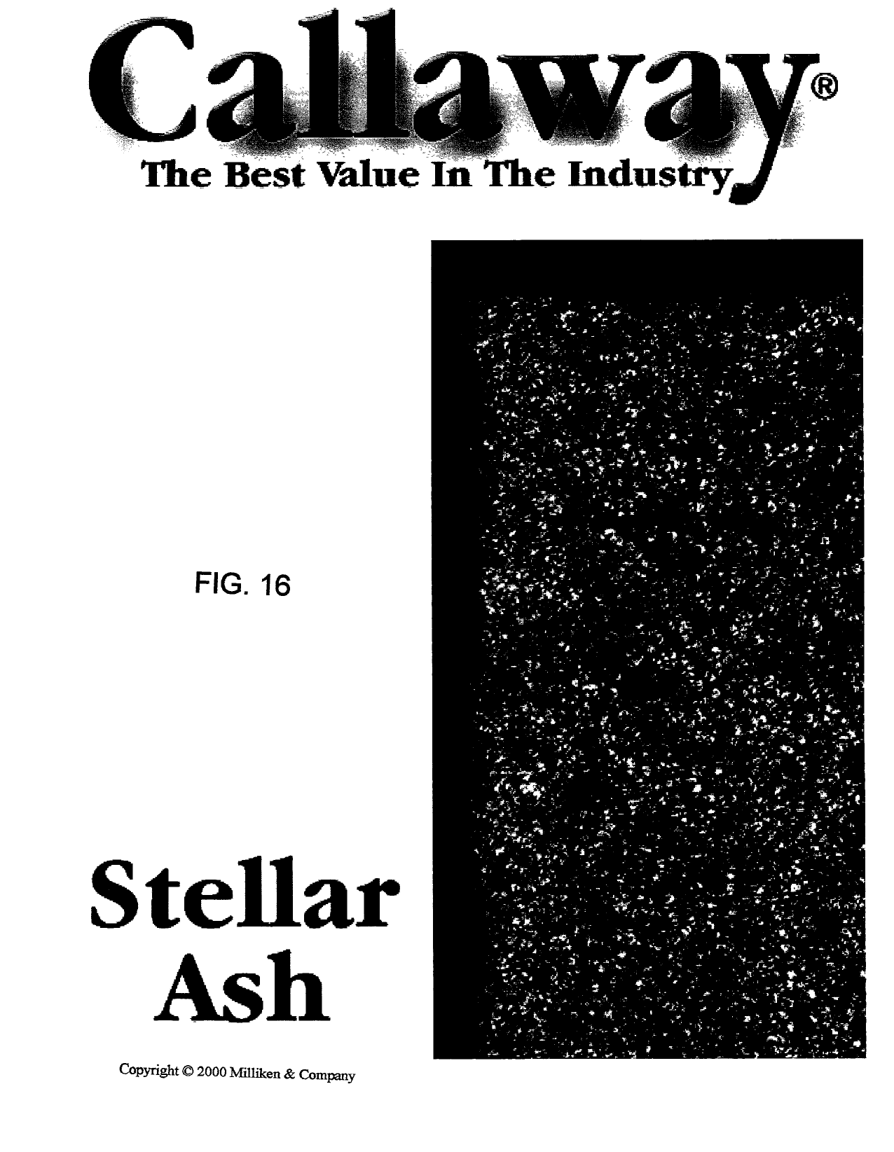

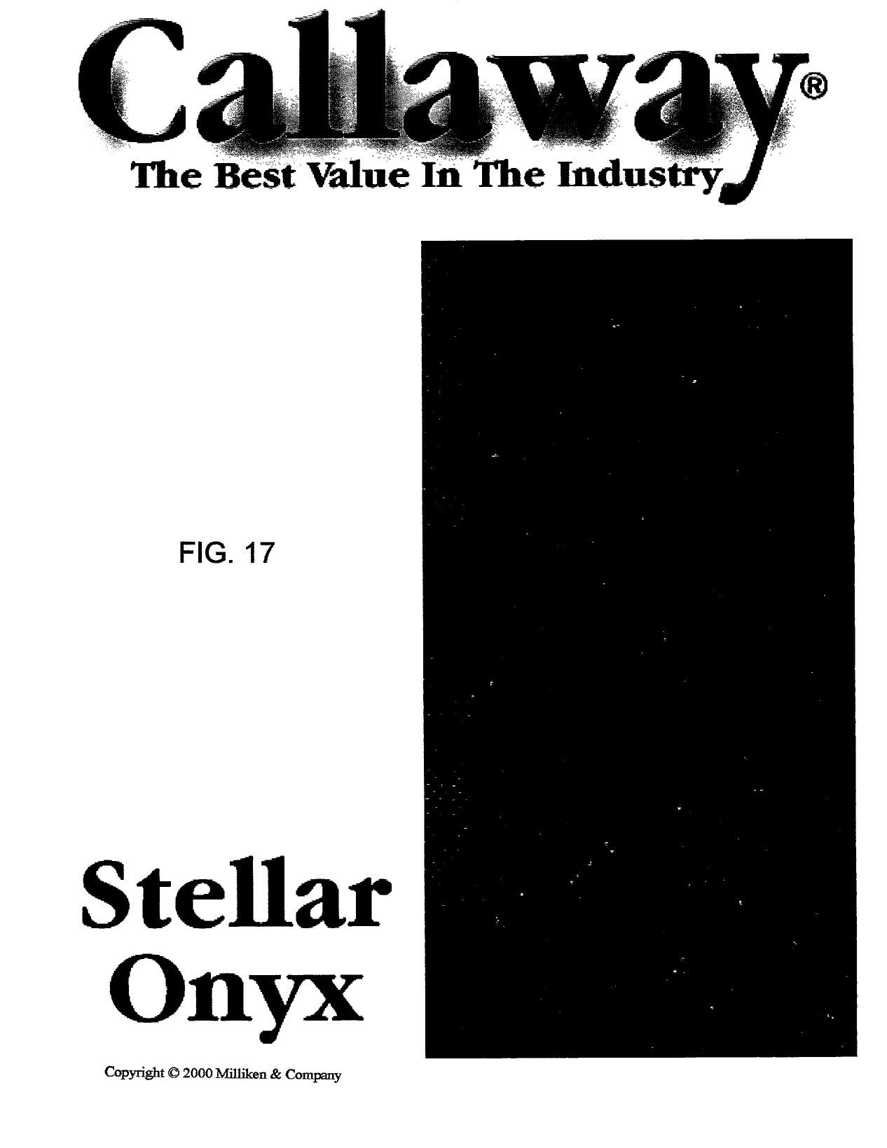

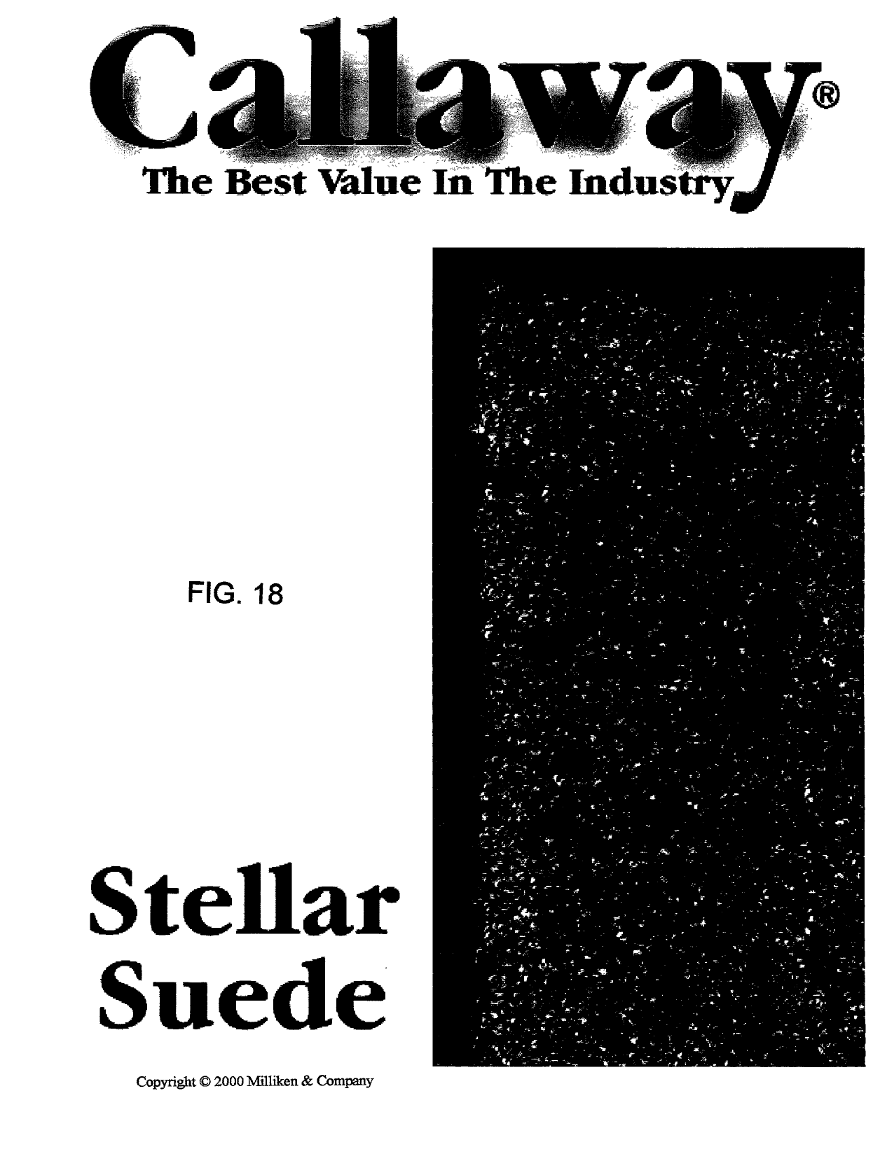

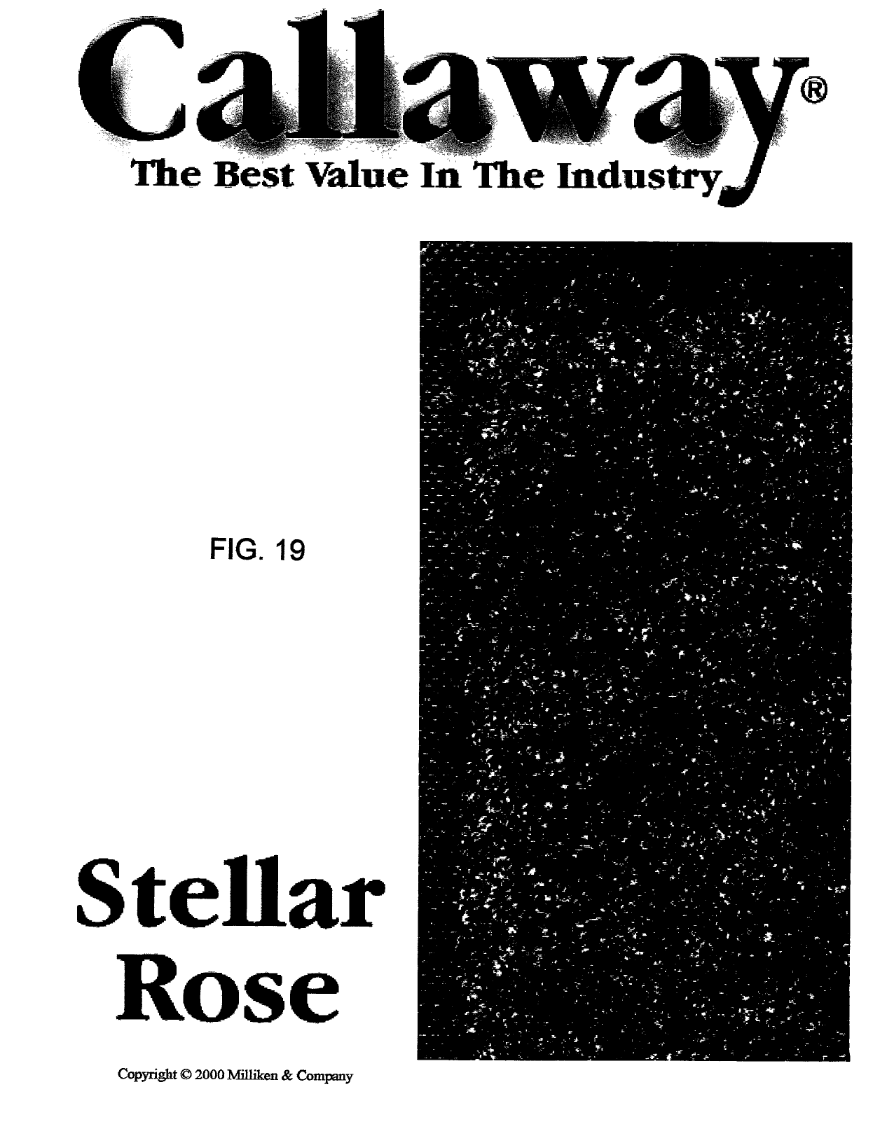

With respect to FIGS. 14-19 of the drawings, there are shown six particular floor mat designs or colorations formed by yarn dyeing or injection dyeing a plurality of colors, preferably three or more colors on the carpet substrate to mimic or provide an appearance similar to that of solution dyed yarn and tufting on a graphics tufting machine, but without using solution dyed yarn and without using a graphics tufting machine. Each of the designs preferably provide a random arrangement of colorations and a selection of one of six colors to match colors at a particular location or site and may provide a designer look to a facility or to provide a selection of colors which can be alternated to provide variation or variety at the location or site of the floor mat placement. Each of these colorations, designs, or patterns is shown on a black rubber backing sheet having an exposed border or edge of about ½″. Although, these floor mats are shown with square corners, it is to be understood that the corners could be rounded, angled, or the like. Also, it is to be understood that the rubber backing may be solid rubber, foamed rubber, multiple rubber layers with, for example, a lower foam layer and an upper solid rubber capping layer, with reinforced borders, with colored borders, and/or the like.

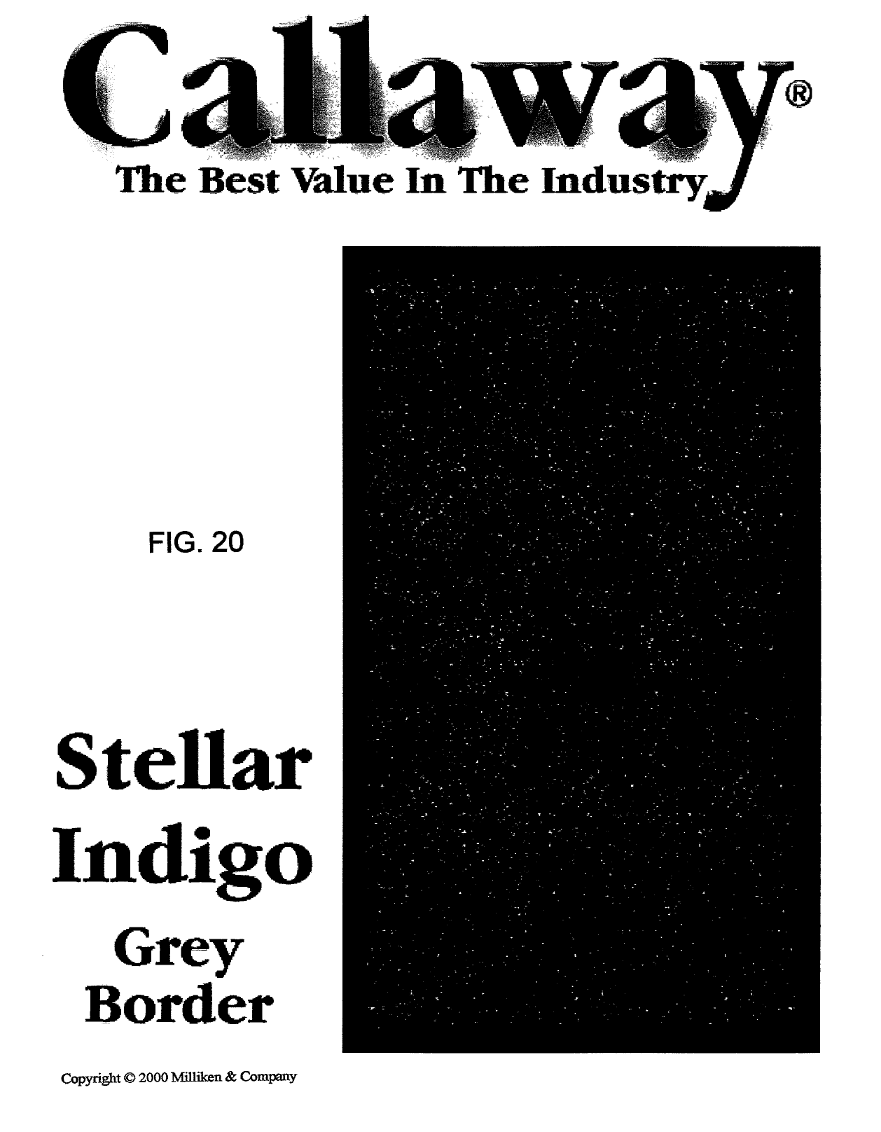

With reference to FIGS. 20-22 of the drawings, there is shown three different examples of the Stellar Indigo floor mat each with a different colored border or backing. More particularly, FIG. 20 shows the floor mat for example a 28″×42″×3/16″ backing and ¼″ pile, with a gray border or gray colored backing.

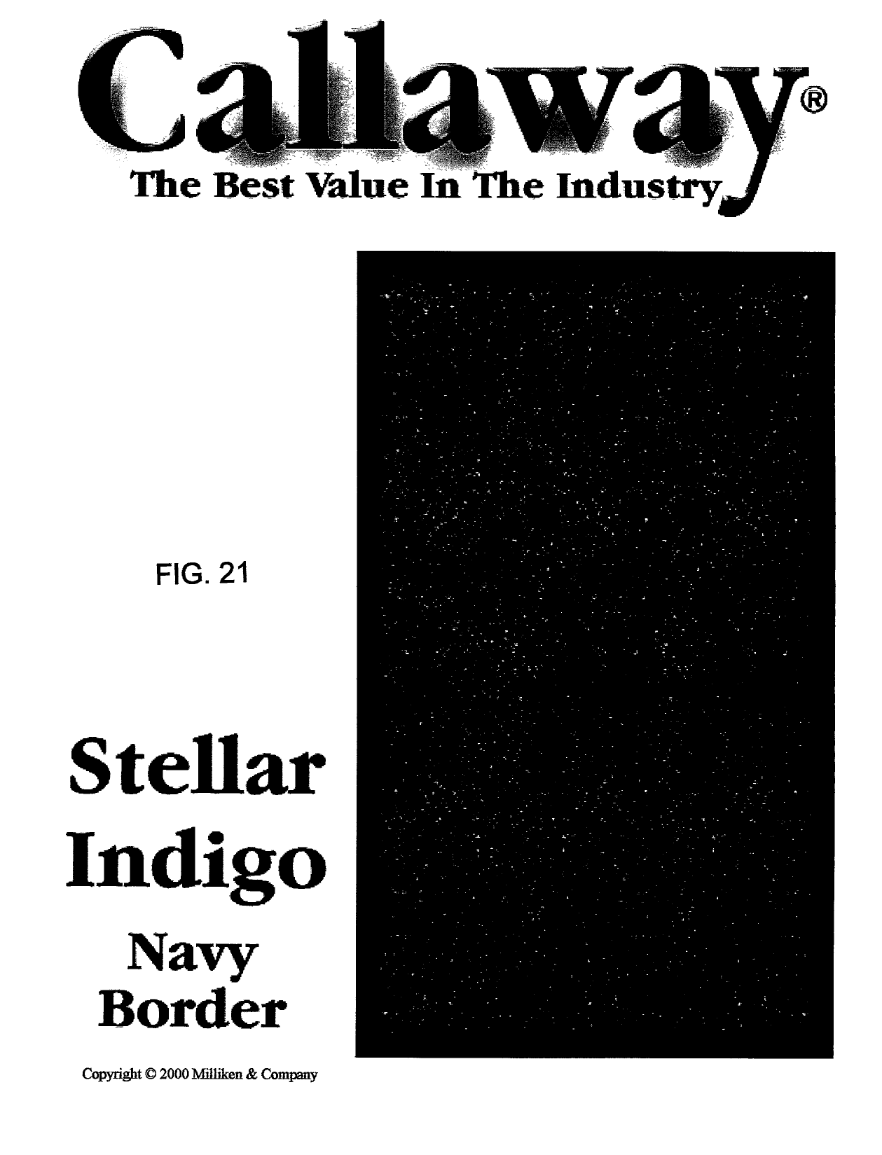

FIG. 21 shows a Stellar Indigo floor mat with a navy or blue colored border or backing.

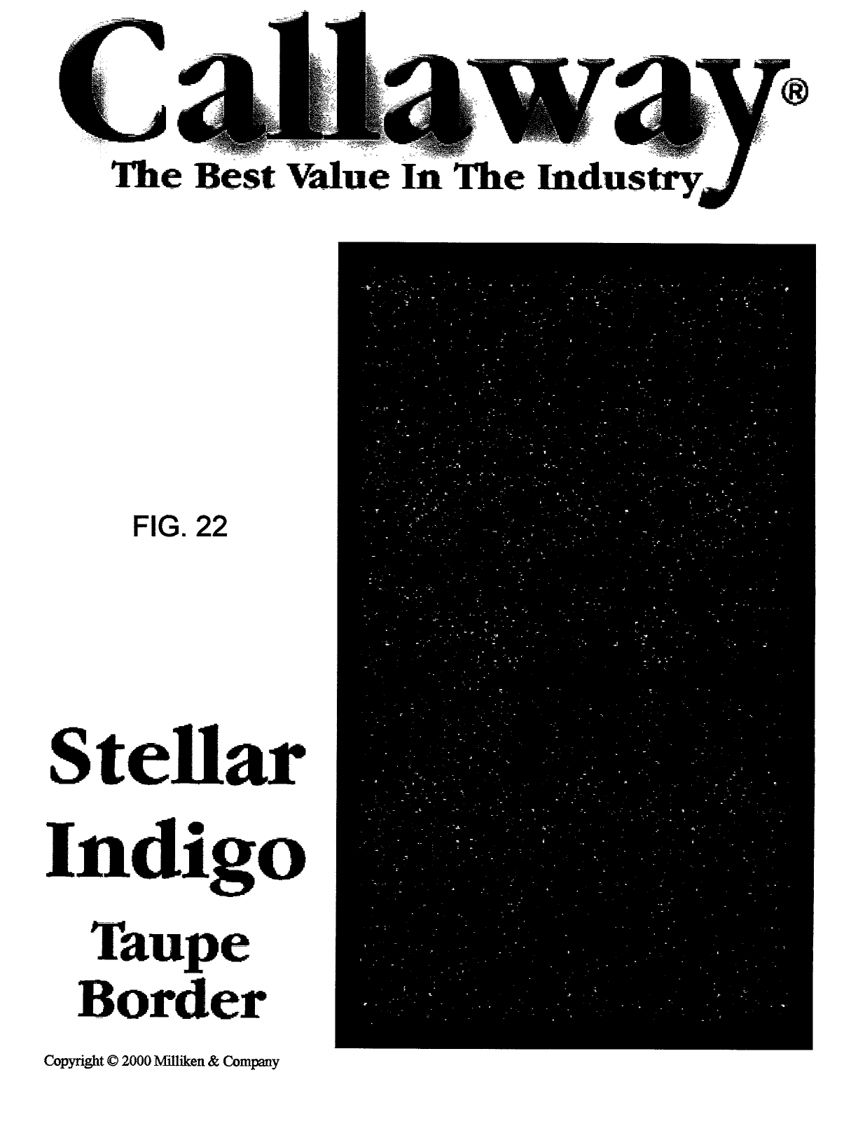

FIG. 22 shows a Stellar Indigo floor mat with a taupe colored border or backing.

Although, four different colors of backing have been illustrated (black, gray, navy blue, taupe), it is contemplated that floor mats could have borders or backing of any color as desired.

In accordance with particular examples of the invention, the colors for each of the designs are as follows:

Stellar Indigo

Navy Blue

Royal Blue

Magenta

Lt. Gray

Stellar Jade

Forest Green

Teal Green

Royal Blue

Magenta

Stellar Ash

Lt. Gray

Charcoal

Beige

Rose

Stellar Onyx

Black

Charcoal

Beige

Lt. Grey

Stellar Suede

Beige

Brown

Rose

Lt. Gray

Stellar Rose

Magenta

Royal Blue

Beige

Red

The colors are listed in highest percentage of color to the lowest percentage of color.

As noted above and in accordance with one embodiment, a particular nonwoven carpet pile backing is selected for the inventive floor mat. Such a nonwoven backing or substrate, again, as noted previously, preferably exhibits a shrinkage rate factor upon standard use, processing, and industrial cleaning procedures (which includes high temperatures washing and drying) of from about 2.0 to about 2.5%. Standard nonwoven substrates exhibit higher shrinkage rates (from about 3.5 to about 7.5%), and may exhibit undesired rippling (curling, etc.) upon utilization of a substrate susceptible to such high degrees of shrinkage through standard use, processing, and industrial cleaning. The carpet pile substrate of the inventive mat is preferably capable of bonding easily and effectively to the rubber backing sheet; provide a carrier for the tufted carpet pile fibers of the inventive mat which will not weaken easily, thereby providing a carpet pile substrate which will not suffer from an appreciable amount of delamination; and weigh from about 3.5 to about 4.5 ounces per square yard in order to reduce the overall weight of the mat (particularly if a solid rubber backing sheet is utilized). Of particular interest as such a substrate are those constructed of synthetic fibers, such as polyesters (preferably polyethylene terephthalate), although natural fibers may suffice so long as the finished product meets the required shrinkage rate criteria. One such substrate is available from Akzo Nobel under the tradename Colback® TM135. This article consists solely of polyester, meets the shrinkage rate, bonding, and non-delamination requirements, and weighs about 4.0 ounces per square yard.

Preferably, the base material for the rubber backing sheet 20 is acrylonitrile-butadiene rubber (NBR) or styrene-butadiene rubber (SBR), just as for the border reinforcement strips or color strips, noted above. Other materials which may also be used include, merely by way of example, hydrogenated NBR and carboxylated NBR although the use of these materials may be cost prohibitive. As will be appreciated, the use of NBR or SBR alone is desirable from a cost perspective. However, these materials may be susceptible to oxidation and ozone attack (referred to as ozonation) due to the presence of unsaturated carbon-carbon double bonds, thereby inviting the addition of ozone resistance agents, or even the addition of ethylene-propylene-diene comonomer rubber (EPDM), as disclosed in U.S. Pat. No. 5,902,662, to Kerr (incorporated by reference). Raw NBR is believed to be available from Bayer under the tradename series Krynac®, such as Krynac® 34E80 or XN 313. SBR may be purchased from Goodyear Tire and Rubber Company.

In the practice of the present invention, a masterbatch of the polymer components is first prepared by mixing the base rubber (either NBR or SBR) with the additive ozone resistant polymer (EPDM) in the desired ratio along with various stabilizers, processing agents, solubilizers, curing catalysts, pigments or colorants, anti-microbial or anti-bacterial agents, conductive agents, antioxidants and scavenging agents (ozone resistance agents), and/or any like additives. Optionally, silica may also be added to provide extra strength to the rubber composition. Stabilizers may include calcium carbonate, for example; waxes can be added as non-limiting processing aids; solubilizers include stearic acid and zinc oxide; curing catalysts include any well known polymerization initiator, including Vulkalent® and Vulkacit® series catalysts, from Bayer Fibers, DOTG (di-ortho-tolylguanidine, from Bayer), DETU (diethyl thiourea, from Sovereign Chemical), MBTS (mercapto-benzothiazole disulfide, from Uniroyal Chemical), and TETD (tetraethylthiuram disulfide, from Uniroyal Chemical); carbon black, lamp black, and the like, are useful as pigments; and Octamine® from Uniroyal Chemical Company, or elemental sulfur can be added to scavenge excess chlorine, oxygen, or ozone. Exemplary compositions of the resultant rubber compositions appear below. These compositions are merely embodiments for the invention and it should be remembered that the main criteria of selection for the particular rubber backing sheet is one which either exhibits roughly the same degree of shrinkage (from about 2.0 to about 2.5% under standard use, processing, and cleaning conditions) as the nonwoven carpet pile substrate or a sheet which possesses a strength modulus of greater than about 1,000 pounds per square inch. Thus, any backing sheet which meets these two overall requirements of performance is encompassed within the scope of this invention.

### EXAMPLE 1

### Foam Rubber Backing Sheet

| | |
|---|---|
| Component | Amount (in Parts) |

| | | |
|---|---|---|
| Krynac ® 34E80 | 30.00 | |
| Krynac ® XN 313 | 70.00 | |
| N-774 Black¹ | 55.00 | |
| Atomite² | 20.00 | |
| DINP³ | 30.00 | |
| Wax 240 | 1.50 | |
| Wax 666 | 2.00 | |
| Octamine ® | 1.00 | |
| Vanox ® ZMTI⁴ | 1.25 | |
| Stearic Acid | 1.50 | |
| Zinc Oxide | 3.00 | |
| Crystex⁵ | 1.75 | |
| DOTG | 0.50 | |
| MBTS | 1.25 | |
| Celogen ® 754⁶ | 4.00 | |
| Vulkalent ® E/C | 1.50 | |
| DETU-75 | 1.00 | |
| Total Amount | 225.25 | parts |

¹Semi-reinforcing carbon black, available from Witco
²Calcium Carbonate
³Antioxidant, diisononyl phthalate, available from Exxon Chemical
⁴Antioxidant, available from R. T. Vanderbilt Co.
⁵Sulfur
⁶Blowing Agent, available from Uniroyal Chemical Co.

The rubber composition is mixed together and eventually formed into a sheet of material.

The rubber mixture is thereafter calendered as a solid sheet of unvulcanized material which is used in the manufacture of the floor mat 12 in the process as described above. As previously indicated and shown above, the rubber backing sheet 20 may include, and in some cases preferably includes, a blowing agent to effectuate the formation of closed gas cells in the rubber during vulcanization. The blowing agent which is preferably used is a nitrogen compound organic type agent which is stable at normal storage and mixing temperatures but which undergoes controllable gas evolution at reasonably well defined decomposition temperatures. By way of example only and not limitation, other possible blowing agents which may be used include: azodicarbonamide (Celogen® AZ-type blowing agents) available from Uniroyal Chemical Inc. in Middlebury, Conn. and modified azodicarbonamide available from Miles Chemical in Akron, Ohio under the trade designation Porofor® ADC-K.

It has been found that the addition of such blowing agents at a level of between about 1 and about 5 parts by weight in the raw rubber composition yields a rubber sheet having an expansion factor of between about 50 and 200 percent. It has been further found that this expansion using these materials yields a final vulcanized rubber backing sheet having a specific gravity of less than about 0.98 and preferably between about 0.5 and about 0.98. With the presence and utilization of a blowing agent during vulcanization, this composition ultimately forms a closed-cell structure foam rubber backing sheet which exhibits a shrinkage rate factor, when exposed to standard use, processing, and industrial cleaning (i.e., rotary washing and centrifugal drying) of roughly about 2.0 to about 2.5%. Furthermore, this backing sheet exhibits a water absorption level of less than about 10%. Such a low level is important to reduce the possibility of warping or puckering of the rubber when used. The foam rubber sheet weighs appreciably less than a solid rubber article, thus, as noted previously, lowering the amount of energy required for proper cleaning and drying of the resultant floor mat on an industrial scale.

The uncured rubber sheet comprising the blowing agent is then assembled with the pile yarns 14 and nonwoven carpet pile backing 16 as previously described. The vulcanization of the rubber backing sheet is then at least partially effected within the press molding apparatus 32 wherein the applied pressure is between 20 and 40 psi. Under the high temperatures and pressure, the nitrogen which is formed by the blowing agent partly dissolves in the rubber. Due to the high internal gas pressure, small closed gas cells are formed within the structure as the pressure is relieved upon exit from the press molding apparatus. In the preferred practice the post cure oven 33 is used to complete the vulcanization of the mat and provide additional stability to the resulting product.

### EXAMPLE 2

### Solid Rubber Backing Sheet

| Component | Amount (in parts) |
|---|---|
| Krynac ® XN 313 | 100.00 |
| N 650 CB¹ | 70.00 |
| Microwhite ® 25² | 25.00 |
| DINP | 30.00 |
| Zinc Oxide | 3.00 |
| Stearic Acid | 1.50 |
| Wax 240 | 1.50 |
| Wax 666 | 2.00 |
| Vanox ® MBPC³ | 3.00 |
| Vanox ® ZMTI | 1.50 |
| Crystex ® | 1.00 |
| MBTS | 0.90 |
| TETD | 0.50 |
| Total Amount | 239.90 |

¹High structure medium reinforcement carbon black, available from Witco
²Calcium carbonate non-reinforcing filler, available from E.C.C. International
³2,2′-methylenebis-(4-ethyl-6-tert-butyl-phenol antioxidant), available from R. T. Vanderbilt Co.

This rubber backing sheet composition exhibited a modulus of about 1,000 pounds per square inch upon vulcanization. In combination with the Colback® TM135 nonwoven substrate, the resultant floor mat exhibited no appreciable rippling after 20 washes.

Tables I and II below provide particular examples of the floor mats shown, for example, in FIGS. 8-22 of the drawings and marketed under the trademark Callaway® by the Kex Division of Milliken & Company.

TABLE I

| | | (B) |
|---|---|---|
| | (A) | CALLAWAY ® |
| PROCESS | PRODUCT | Broadloom Pattern |
| ELEMENT | CHARACTERISTICS | Solids and Tacs |
| | END USE | |
| | I. CONSTRUCTION (FINISHED) | |
| YARN | PILE FIBER SUPPLIER | Dupont |
| | PILE FIBER TYPE | NYLON 6,6 |
| | PILE FIBER CROSS SECTION | TRILOBAL |
| | PILE FIBER LUSTER | BRIGHT |
| | PILE, TOTAL DENIER PER YARN | 1230 |
| | PILE FIBER AVG. DEN. PER FILMNT | 17 |
| | PILE, # OF FILMNTS PER YARN | 72 |
| | PILE YARN, TWIST, T.P.I. | 6.0 (“Z”) |
| | PILE YARN, # OF PLIES | 2 |
| | PILE, ANTISTAT FIBERS PRES | YES |
| | PILE YARN, # TUFTS/INCH | 7.7 |
| TUFTING | TUFTING GAUGE, INCHES | 5/32 (0.156) |
| | PILE HGT, INCHES | 24/64 (.375) |
| | PILE OZ./YD² | 18.3 |
| | SUBSTRATE MATERIAL | NYLON COATED |
| | | POLYESTER |
| | SUBSTRATE CONSTRUCTION | NONWOVEN |
| | SUBSTRATE OZ. PER SQ. YD. | 4.0 |
| RANGE DYEING | METHOD | INJECTION DYE |
| | SPEED | 30 F.P.M. |
| RUBBER | TOTAL MAT WGHT, LBS. (3 × 5) | 6.2 |
| | RUBBER TYPE | NITRILE 40% |
| | BODY STOCK, MILS | 60 |
| | BORDER STOCK, MILS, SIDES | 60 |
| | BORDER STOCK, MILS, ENDS | 60 |
| | RUBBER OZ/SQ YD | 56.2 |
| | BACKING CONSTRUCTION | 1 PIECE |
| | PERFORATIONS PRES. DESCP | YES |
| | GRIPPERS PRESENT | YES |

TABLE II

| | | (B) |
|---|---|---|
| | (A) | CALLAWAY ® |
| PROCESS | PRODUCT | Broadloom Pattern |
| ELEMENT | CHARACTERISTICS | Solids and Tacs |
| | END USE | |
| | I. CONSTRUCTION (FINISHED) | |
| YARN | PILE FIBER SUPPLIER | Dupont |
| | PILE FIBER TYPE | NYLON 6,6 |
| | PILE FIBER CROSS SECTION | TRILOBAL |
| | PILE FIBER LUSTER | BRIGHT |
| | PILE, TOTAL DENIER PER YARN | 400-6000 |
| | PILE FIBER AVG. DEN. PER FILMNT | 5-100 |
| | PILE, # OF FILMNTS PER YARN | 4-1200 |
| | PILE YARN, TWIST, T.P.I. | 1-20 |
| | PILE YARN, # OF PLIES | 1-5 |
| | PILE, ANTISTAT FIBERS PRES | YES |
| | PILE YARN, # TUFTS/INCH | 7.7 |
| TUFTING | TUFTING GAUGE, INCHES | 1/10-¼ (0.10-0.25) |
| | PILE HGT, INCHES | 0.25-0.50 |
| | PILE OZ./YD.² | 12-24 |
| | SUBSTRATE MATERIAL | POLYPROPYLENE, NYLON |
| | SUBSTRATE CONSTRUCTION | WOVEN, NONWOVEN |
| | SUBSTRATE OZ. PER SQ. YD. | 2.5-5.0 |
| RANGE DYEING | METHOD | INJECTION DYE |
| | SPEED | 30 F.P.M. |
| RUBBER | TOTAL MAT WGHT, LBS. (3 × 5) | 6.2 |
| | RUBBER TYPE | NITRILE 40% |
| | BODY STOCK, MILS | 25-100 |
| | BORDER STOCK, MILS, SIDES | 20-125 |
| | BORDER STOCK, MILS, ENDS | 20-125 |
| | RUBBER OZ/SQ YD | 35-75 |
| | BACKING CONSTRUCTION | 1-4 |
| | PERFORATIONS PRES. DESCP | YES |
| | GRIPPERS PRESENT | YES |

In accordance with one embodiment of the present invention, the mats are:

The Best Value Mat In The Industry

The Best Mat Available

Premium Nylon 6,6 Fiber

100% Yarn Dyed

Plush Fabric Face

Anti-Slip Nitrile Rubber Backing

Stain Resistant

Launderable

Long Lasting

Sizes Available: K (71 cm×106 cm), L(71 cm×150 cm), T (71 cm×254 cm), M(124 cm×144 cm)

Colors Available: Stellar Indigo, Stellar Jade, Stellar Ash, Stellar Onyx, Stellar Suede, Stellar Rose

In accordance with a particular aspect of the present invention and as shown for example in FIGS.14-22 of the drawings, the floor mats are dyed, jet dyed, injection dyed, printed, or the like to look like they are made from solution dyed yarn which has been graphics tufted.

The carpet pile substrate or tufted substrate may be formed from white yarn, space dyed, solution dyed, or the like and then overprinted or dyed in a jet dying, injection dyeing, or printing machine. By jet dyeing or injection dyeing the final design, coloration, pattern, and/or the like, one can reduce inventory cost, enable the creation of more intricate and interesting designs, create personalized or logo mats, and the like.

The designs or patterns such as shown in FIGS. 14-22 of the drawings are similar to solution dyed graphics tufted designs and help to hide dirt, debris, soiling, and the like.

In accordance with another aspect of the present invention, each of the floor mats of a particular mat offering or system are offered at a single width, for example, 28″ to provide for standardization of storage racks, racks and delivery vehicles, equipment, processing, and the like.

In accordance with another aspect of the present invention, one or more of the components of the floor mats is treated with an anti-microbial or anti-bacterial agent.

In accordance with another aspect of the present invention, the face weight of the carpet substrate and the backing weight of the rubber backing of the floor mat have been produced to provide a lighter weight and yet still durable floor mat or system of floor mats. The lower weight reduces manufacturing cost, reduces transportation or shipping costs, reduces laundering cost, reduces fuel consumption by delivery trucks, reduces the weight of the mats as they are handled, and the like.

In accordance with another aspect of the present invention, the floor mats are jet dyed or injection dyed with a coloration, pattern and/or design that looks like a space dyed or solution dyed pattern or design. It is preferred to use a white or light pile substrate, for example a white yarn or a light beige yarn that is jet dyed, injection dyed, printed, or the like. Also, it is preferred to use three or more colors when jet dying, injection dyeing, printing, ink jet printing, or the like.

In accordance with one embodiment of the present invention, floor mats have a carpet or fabric substrate which is jet dyed in a manner providing a solution dyed look to the final product.

In accordance with another aspect of the present invention, the floor mat may include a dimpled pattern, cleats, nubs, protrusions, and/or the like on the back surface to provide a non-skid or anti-creep surface. Also, the upper surface of the floor mat especially the border, may include dimples, protrusions, nubs, cleats, or the like for either aesthetics or function (FIGS. 14-22). Also, the corners of the mat may be rounded, for example by cutting or punching the corners following vulcanization and separation of the floor mats.

In accordance with another aspect of the present invention, the floor mats may have a black edge and back surface and a non-black or color other than black to the top surface or at least along the border or edge of the top of the floor mat. This can be accomplished by using, for example, a black rubber backing sheet, and non-black reinforcing strips or coloring strips, by painting the color onto the upper border or edge, using colored polymer films or materials, using a colored frame, or using a colored top layer or cap over the black backing sheet.

In accordance with the present invention, it is preferred to provide a washable, aesthetically pleasing, light, smaller, colored border, perforated, and/or the like floor mat, floor mat system, and the like. The mats are perforated, for example, as described in U.S. Pat. No. 4,653,366 hereby incorporated by reference. Such perforations allow water to pass through the mat during the spin cycle of laundering so as to avoid the necessity of drying the mats or at least to reduce the drying time.

Color can be provided to the rubber backing sheet, border, edge, or the like of the floor mat using a colored nitirile rubber, a TPE colored layer, a TPE colored rubber edge strip, frame, or border, or the like.

In accordance with one aspect of the present invention, the carpet substrates are formed by tufting nylon 6,6 in a nonwoven polyester backing or carrier, jet dyeing the tufted substrate, slitting the substrate along its length, and then cross cutting the slit substrate to form the individual floor mat size carpet substrates. Although it is not required in many applications, the back of the carpet substrate may be coated with an adhesive, latex, hot melt, or the like to enhance the attachment to the rubber backing sheet and/or to help hold the tufts in the pile backing or carrier.

In accordance with another aspect of the present invention, a plurality of individual floor mats are formed in a process of placing a plurality of individual floor mat carpet substrates on a large rubber backing sheet which will hold two or more carpet substrates, vulcanizing, and then cutting the rubber backing sheet between the carpet substrates to form individual floor mats. These individual floor mats may not need additional trimming following the cutting or separation.

Although it is preferred to dye the carpet substrate prior to vulcanization and attachment to the rubber backing sheet, it is possible to place an undyed carpet substrate on a rubber backing sheet, vulcanize the two together, and then run the floor mat through a jet dyeing or injection dyeing machine to dye the carpet substrate.

In accordance with the present invention, the floor mats could be borderless (no rubber backing extending beyond the edge of the carpet substrate), have one or more side borders, have one or more end borders, or have both end and side borders.

Although it is preferred to have a washable floor mat, floor mats may be constructed using a bonded rather than tufted carpet substrate, especially when producing a non-washable floor mats.

In accordance with one example, the floor mat has a total mat weight of less than about 6.5 lbs. for a 3′×5′ mat, preferably less than about 6.4 lbs., and most preferably less than about 6.25 lbs.

In accordance with another example, the mat has a rubber weight of less than about 58 oz./sq. yd., preferably less than about 57 oz./sq. yd., and more preferably less than about 56.5 oz./sq. yd.

In accordance with another example, the mat has a pile face weight of less than about 20 oz./sq. yd., preferably less than about 19 oz./sq. yd., and more preferably less than about 18.5 oz./sq. yd.

In accordance with one example, a plurality of mats, for instance, 2-16 mats, are produced simultaneously by placing a plurality of carpet or tufted or fabric pieces atop a single rubber backing sheet prior to vulcanization.

In accordance with another example, the mat has a low pile height which fits well under a door (for example, about 24/64 inch).

In accordance with one particular example of the present invention, the floor mat has an about 60 mil thick rubber backing formed of either a 60 mil thick black solid rubber backing, a 50 mil thick black solid rubber backing and a 10 mil thick colored top layer, a 60 mil thick black rubber backing with a colored frame or border, a 40 mil thick black rubber backing with a 20 mil thick colored border or edging, or a 40 mil thick black backing with a 20 mil thick upper layer or cap which may be colored a color other than black or may be black. By using a 60 mil thick solid rubber backing, the reinforcement strips may be eliminated.

In accordance with the present invention, the backing of the floor mat may be polyurethane, latex, SBR, Neoprene®, polychloralprene rubber, foam, nitrile rubber, and/or the like.

While the invention has been described and disclosed in connection with certain preferred embodiments and procedures, these have by no means been intended to limit the invention to such specific embodiments and procedures. Rather, the invention is intended to cover all such alternative embodiments, procedures, and modifications thereto as may fall within the true spirit and scope of the invention as defined and limited only by the appended claims.

What we claim is:

1. A floor mat system comprising a plurality of floor mat sizes each having the same width and each floor mat comprising
a carpet pile backing or carrier;
a pile material tufted into said carpet pile backing which forms a pile surface on one side of said pile backing; and
a vulcanized rubber backing sheet integrated to the other side of the pile backing.

2. The floor mat system of claim 1, wherein said rubber backing sheet comprises a blowing agent to produce a closed cell structure foam rubber.

3. The floor mat system of claim 1, further comprising solid vulcanized rubber reinforcement strips along at least one of the borders of each mat.

4. The floor mat system of claim 1, wherein each said floor mat possesses suitable flexibility to be laundered on a regular basis in a standard industrial washing machine without appreciably damaging said mat or said machine.

5. The floor mat system of claim 1, wherein said carpet pile backing is a nonwoven polyester.

6. The floor mat system of claim 1, wherein each of said floor mats have a width of about 28 inches.

7. The floor mat system of claim 1 wherein said carpet pile backing is comprised of natural or synthetic fibers or blends thereof.

8. The floor mat system of claim 1 wherein said pile material is comprised of natural or synthetic fibers or blends thereof.

9. The floor mat system of claim 1 wherein said pile material is comprised of 100% jet dyed nylon fibers.

10. The floor mat system of claim 1 wherein said carpet pile backing weighs from about 3.5 to about 4.5 ounces per square yard.

11. The floor mat system of claim 1 wherein said carpet pile weighs less than about 20 ounces per square yard.

12. The floor mat system of claim 1, wherein said floor mats are offered in 4 sizes and 6 colors.

13. The floor mat system of claim 1, wherein said backing sheet is an about 60 mil thick solid rubber.

14. The floor mat system of claim 1, wherein said floor mats may have one of three border colors.

15. The floor mat system of claim 1, wherein each of said mats has a total mat weight of less than 0.60 lbs./sq. ft.

16. The floor mat system of claim 1, wherein each of said floor mats is one of a plurality of floor mats formed simultaneously from a single backing sheet.

17. The floor mat system of claim 1, wherein the sizes of mats are 28″×42″, 28″×59″, 49″×57″ and 28″×100″.

18. A flooring mat having a pile surface which is jet dyed to look like a floor mat made of solution dyed yarn tufted with a graphics tufting machine.

19. The floor mat of claim 18, wherein the mat is dyed with at least three different colors.

20. A method of simultaneously forming a plurality of floor mats, comprising placing a plurality of individual floor mat carpet substrates on a large rubber backing sheet, vulcanizing the carpet substrates and backing sheet, and cutting the vulcanized backing sheet between the carpet substrates to form individual mats.

21. A floor mat produced by the method of claim 20.
